(19) United States
(12) Patent Application Publication
(10) Pub. No.: US 2026/0100142 A1
(43) Pub. Date: Apr. 9, 2026

(54) Intuitive graph guided question-answer for interactive education experiences

(71) Applicant: Nicholas X. Wang, San Jose, CA (US)

(72) Inventor: Nicholas X. Wang, San Jose, CA (US)

(21) Appl. No.: 18/831,236

(22) Filed: Oct. 4, 2024

(51) Int. Cl. G09B 7/06; G06N 20/00

(52) U.S. Cl. CPC G09B 7/06; G06N 20/00

(57) ABSTRACT

An intuitive optimized method for answering a question with graphical guided steps includes: setting or adjusting an Intuitive Level Metric (ILM); receiving a question with multiple choice answers; generating a causal graph corresponding to the question; transforming both the question and the causal graph into a concatenated text stream and embedding; inputting the embedded stream into an ILM-optimized machine learning module to generate an output text; processing the output text stream to generate an answer and a list of pairs of text steps and drawing commands; processing the list of pairs sequentially, first rendering the text step and then creating a drawing based on the command; and outputting the final answer choice.

### FIELD OF THE DISCLOSURE

The present disclosure relates to the field of question-answer interactive technologies and, more particularly, relates to a method and device for question-answer with intuitive graph guided mechanisms for interactive education experiences.

### BACKGROUND

Education shapes our society's future, yet many students struggle with STEM (science, technology, engineering, and math) subjects. While ChatGPT is widely used to answer questions, it primarily focuses on language rather than math and logic. Researchers are enhancing LLMs (large language models) to improve problem-solving capabilities, but intuitive education tools remain nascent and lack visual elements.

### BRIEF SUMMARY OF THE DISCLOSURE

One aspect of the present disclosure provides solutions that combine text with intuitive, graph-guided mechanisms to create interactive educational experiences, making complex STEM concepts more accessible and understandable. One aspect of the present disclosure provides a method for answering questions using graphical guided steps, designed to enhance the intuitiveness and comprehensibility of the answers. The method begins by setting or adjusting an Intuitive Level Metric (ILM), which determines the balance between textual and graphical information and many other factors. Upon receiving a question with multiple-choice answers, a causal graph that represents the logical structure of the question is generated. This question and the corresponding causal graph are transformed into a concatenated text stream and go through a standard embedding process like that of GPT (generating pre-trained transformer), which include processes such as tokenization, embedding lookup, positional encoding, and so on. This embedded stream is then processed by an ILM-optimized machine learning module, which can be derived on top of an open source LLM such as Llama or GPT-2, or developed from scratch, to generate an output text. The output text includes an answer and a list of paired text steps and drawing commands, which are processed sequentially to render the text and create corresponding drawings, thereby producing a final answer choice that is both informative and visually intuitive.

Another aspect of the present disclosure provides a device for answering questions with graphical guided steps includes a memory storing program instructions and a processor configured to execute these instructions. The device is capable of setting or adjusting the Intuitive Level Metric (ILM), receiving questions with multiple-choice answers, and generating causal graphs related to the questions. It transforms both the questions and the causal graphs into a concatenated text stream, which is then embedded and input into an ILM-optimized machine learning module. The device processes the resulting output text stream to generate an answer and a list of pairs of text steps and drawing commands. By processing these pairs sequentially, the device first renders the text step and then creates a drawing based on the command, ultimately outputting the final answer choice in an intuitive manner.

Another aspect of the present disclosure provides a system for answering questions with graphical guided steps comprises a terminal device and a cloud server that work in tandem. The terminal device is responsible for setting or adjusting the Intuitive Level Metric (ILM), receiving questions with multiple-choice answers, and sending these questions to the cloud server. The cloud server handles the more complex tasks of generating causal graphs, transforming the questions and graphs into a concatenated text stream, embedding this stream, and processing it through an ILM-optimized machine learning module, to generate an output text. The text stream is then sent back to the terminal device, which processes it to generate an answer and a list of paired text steps and drawing commands. The terminal device processes these pairs sequentially, rendering text steps and creating corresponding drawings to produce a final answer choice. Communication between the terminal device and the cloud server is facilitated via a programming interface (e.g., HTTP API or WebSockets), ensuring efficient data transfer and real-time responsiveness.

Other aspects of the present disclosure can be understood by those skilled in the art in light of the description, the claims, and the drawings of the present disclosure.

### BRIEF DESCRIPTION OF THE DRA WINGS

The following drawings are merely examples for illustrative purposes according to various disclosed embodiments and are not intended to limit the scope of the present disclosure.

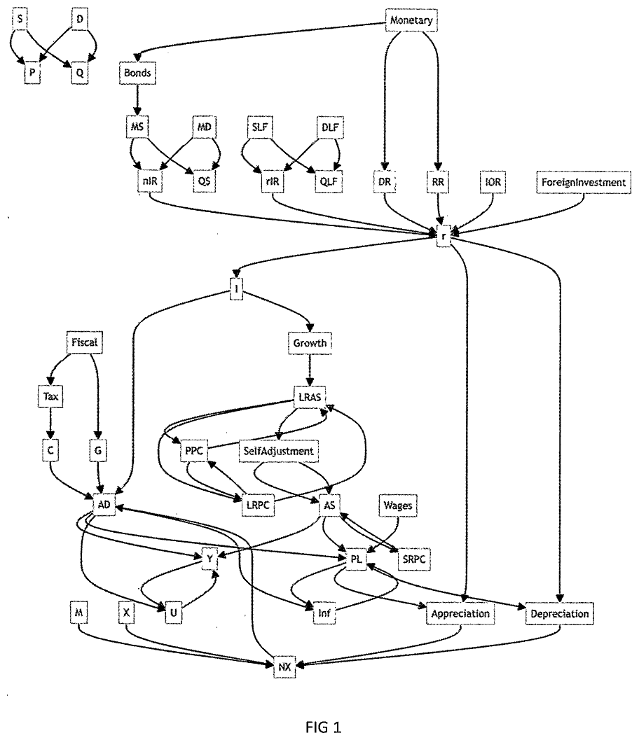

FIG. 1 illustrates an exemplary causal graph according to some embodiments of the present disclosure;

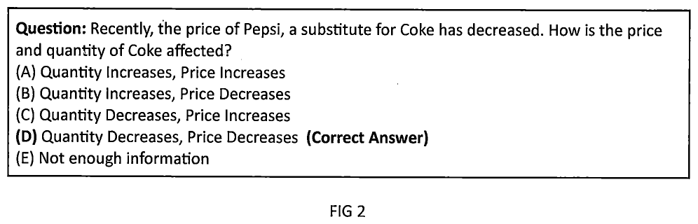

FIG. 2 illustrates an exemplary multi-choice question and answer according to some embodiments of the present disclosure;

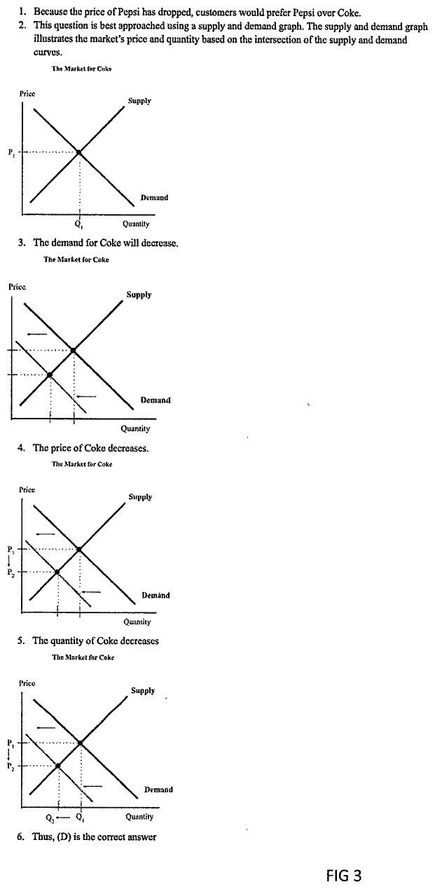

FIG. 3 illustrates an exemplary graph guided step-by-step answer with diagram generated by an exemplary GraphGPT according to some embodiments of the present disclosure;

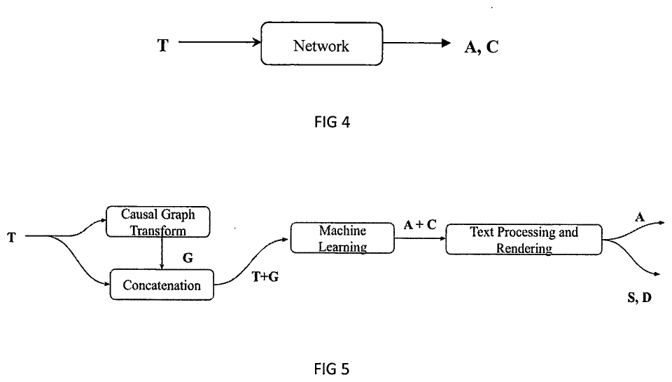

FIG. 4 illustrates an exemplary neural network to resolve question-answer training according to some embodiments of the present disclosure;

FIG. 5 illustrates an exemplary GraphGPT neural network architecture to resolve question-answer training according to some embodiments of the present disclosure;

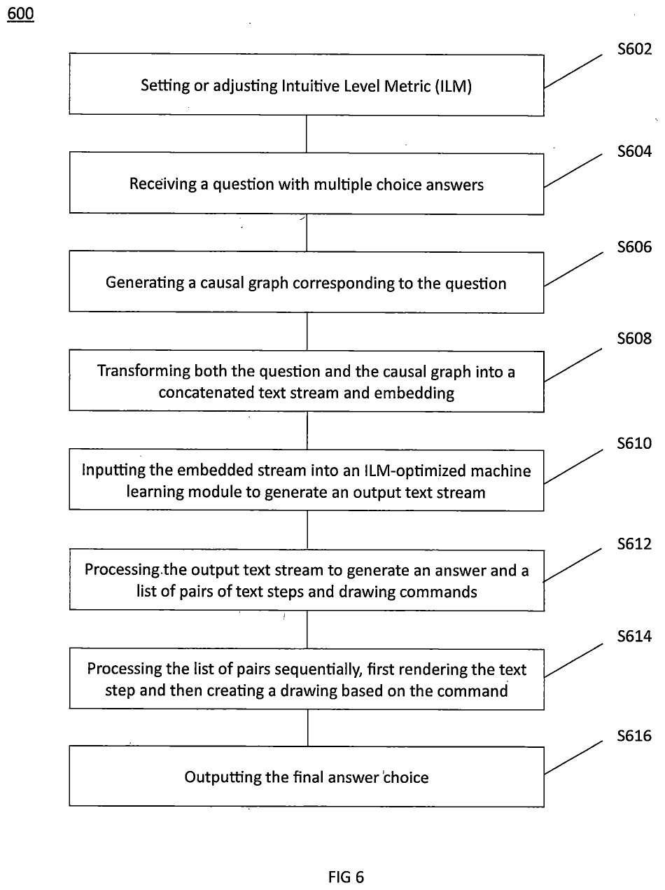

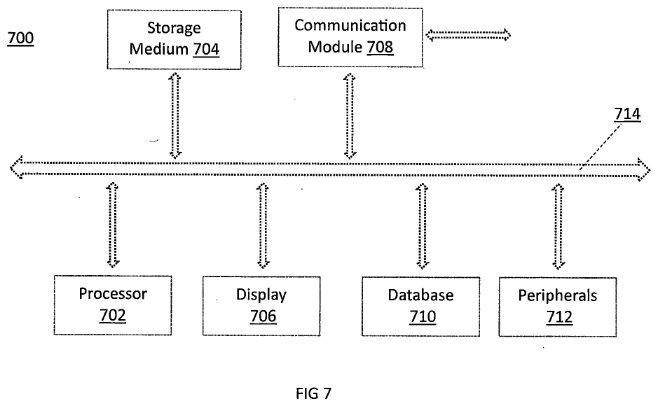

FIG. 6 illustrates a flowchart of an exemplary intuitive method for answering a question according to some embodiments of the present disclosure; and

FIG. 7 illustrates a schematic structural diagram of an exemplary intuitive question answering device according to some embodiments of the present disclosure.

### DETAILED DESCRIPTION

Reference will now be made in detail to exemplary embodiments of the invention, which are illustrated in the accompanying drawings. Hereinafter, embodiments consistent with the disclosure will be described with reference to the drawings. Wherever possible, the same reference numbers will be used throughout the drawings to refer to the same or like parts. It is apparent that the described embodiments are some but not all of the embodiments of the present invention. Based on the disclosed embodiments, persons of ordinary skill in the art may derive other embodiments consistent with the present disclosure, all of which are within the scope of the present invention.

Education shapes the future of our society, making it a central focus of social impact. However, a recent report by Collegeboard revealed that 60-70% of students scored a three or below on AP exams for STEM courses such as Physics, Macroeconomics, and Calculus. After school, students often have limited resources to address concepts they didn't understand in class. Since the emergence of ChatGPT, many students have been using it to answer their questions outside of school. ChatGPT is free, which has led to its extensive usage recently.

However, it has been noted that ChatGPT primarily focuses on language understanding and generation rather than solving math and logic problems. Consequently, many recent researchers are working on advancing large language models (LLMs), such as various versions of GPTs (e.g., GPT-3, GPT-4, Llama), to improve mathematical problem-solving capabilities. Researchers have investigated chain-of-thought prompting, which involves a series of intermediate reasoning steps that enable complex reasoning. Another approach proposed a tree-based representation of math language that preserves the semantic and structural properties of mathematical expressions, facilitating their connection with natural language token embeddings used in LLMs. Additionally, researchers have targeted Olympiad-level geometry problem-solving and proposed a theorem prover for Euclidean plane geometry that synthesizes millions of theorems and proofs across different levels of complexity, eliminating the need for human demonstrations.

On the other hand, intuitive education using advances in LLMs is emerging. For example, Khan Academy, a non-profit educational organization, created a tool called Khanmigo built on GPT-4. This tool aims to help students find answers through step-by-step interactions and develop their logical reasoning skills. However, these efforts are still in their nascent stages, and ChatGPT often struggles to justify its answers with clear logical steps, providing wordy and unintuitive explanations for beginners.

Many STEM subjects require students to have strong logic reasoning, a deep understanding of theorems, and the ability to develop intuition. Explaining concepts using only text is often insufficient. The saying “a picture is worth a thousand words” emphasizes that diagrams and graphs can be more intuitive than paragraphs of text. Therefore, an AI (artificial intelligence) solution for intuitive education that includes visual elements would be highly valuable. This approach could be effectively applied in fields such as Macroeconomics, Physics, Chemistry, Biology, Algebra, Geometry, and Calculus.

In many STEM subjects, cause-and-effect relationships drive logical reasoning, making the study of causality essential. A causal graph, as shown in FIG. 1, can define the relationships among associated components of the logical reasoning. It has been observed that causal graphs can act as a bridge between a question and an answer. Initially, the causal graph can be mapped from the question, and the logic for the answer can be derived step-by-step on the causal graph. This method corresponds to both text and visual presentations for each step, making the answer more intuitive for students.

The present disclosure provides a method and a device intuitive education. In a typical self-supervised learning approach, a pretext task is an artificial task created to help the model learn useful representations of data without requiring labeled data. Additionally, masked prediction is a popular method used in NLP (Natural Language Processing) and computer vision, where certain parts of the input data (such as words in a sentence or pixels in an image) are deliberately hidden or “masked.” The model is then tasked with predicting the masked or missing elements based on the surrounding context. In this disclosure, the pretext task is to create “free” training data by generating a causal graph from the input question. Then, the causal graph and the original text question are merged into a text stream and sent into a machine learning model, e.g., a GPT model, for training. Masked prediction is used to predict a preliminary answer. This preliminary answer is further processed to generate step-by-step diagrams as well as a text answer. The diagram drawing is driven by commands contained in the preliminary answer, which are learned from the causal graph.

The machine learning model such as a GPT model mentioned above refers to a general large language model, in some embodiments, it can be GPT-2, or GPT-3; in some other embodiments, it can be Llama 3.

The present disclosure underscores the significance of “graphs”, as a “graph” refers both to “a diagram that relates two variables” in mathematical and scientific contexts, and “a collection of nodes and edges” in causal graph theory. The use of scientific graphs aids in visualizing concepts, while causal graphs enhance logical coherence in responses. This combo approach integrates textual and visual elements to provide more intuitive answers for students, and it is called GraphGPT for short.

The present disclosure proposes a novel self-supervised learning approach that combines masked prediction with transform prediction using causal graphs, significantly enhancing explanation accuracy. By employing causal relationship analysis and causal graph representations, GraphGPT can generate coherent sequences of logical steps alongside diagrams.

In some embodiments of the present disclosure, the examples primarily focus on Macroeconomics, yet the theories and technology are applicable beyond this field. Macroeconomics, a crucial social science, studies the behavior of national economies. Economic entities are predominantly curves and variables, exhibiting two primary trajectories or trends: increase and decrease (as shown in Table 1). Economic graphs depict relationships between two variables plotted on x- and y-axes, where each point represents a duo of coordinates defined by two variables. Typically, the equilibrium point signifies the intersection of two curves. However, under specific conditions, this point may not necessarily be at equilibrium. For instance, the graph depicting Supply and Demand which models the relationship between Price and Quantity of a product. The equilibrium between supply and demand determines the price and quantity. A shift in demand alters this equilibrium, subsequently affecting price and quantity. In addition to graphs, fundamental relationships exist such as “price increase=⇒inflation” and “more imports=⇒less GDP.” Macroeconomic problems can intuitively be addressed using Economic Graphs and Economic Relationships, rather than relying on rote memorization of facts and properties. Representing these relationships, a Causal Graph provides a straightforward method.

TABLE 1

| | INCREASE | DECREASE |
|---|---|---|
| Curves | Move right | Move left |
| Variables | Increase | Decrease |

For high school students studying Macroeconomics, receiving a question and its solution in text (as shown in FIG. 2) can make it challenging to understand how each step leads to the final answer. What students truly need is a step-by-step explanation that is both intuitive and accompanied by visual representations (as shown in FIG. 3). This approach not only enhances comprehension of the concepts but also aids in long-term retention of the concept learned and the skills acquired.

In some embodiments, let us denote by T the question that needs to be solved, A the final answer, S the logical steps needed to reach the solution, D the diagrams or scientific graphs that pair with S, N the total number of logical steps, thus S={S₁, S₂, . . . . S_{N}} and D={D₁, D₂, . . . . D_{N}}. As shown in FIG. 3, e.g., N=6, and the 4 diagram in FIG. 3 represents the ones associated with the steps that requires drawing, that is, some of the elements in D could be NULL (meaning empty and no need to draw). Hence, the problem can be formulated as max P (A, S, D|T). To simplify the problem, it is possible to define a list of commands C that can be utilized to derive S and D. The syntax of commands C is straightforward and follows the format of {<Operation> <Operand>}. The operations available include NEW (initiating a graph), LEFT or RIGHT (moving direction of a curve), and INCREASE or DECREASE (trending of a quantity). The operands can be one of five types: graph, curve, variable, point, and Economic Policy (e.g., Fiscal). It is important to note that the specific design of commands C can vary depending on the subject being studied, as different subjects may require different types of diagrams. While a universal command set can be defined for general use, some subjects might necessitate more complex command structures. This approach allows for a structured way to manipulate and analyze graphs and curves, facilitating clearer understanding and application across various subjects. Hence the earlier formalized problem can be rewritten as: max P (A, C|T), which can be resolved with a neural network model as shown in FIG. 4. There are multiple approaches to consider, but an exemplary solution is to employ a GPT model like GPT-3.5. By feeding it with question-answer pairs extracted from a textbook and utilizing masked prediction in unsupervised learning, we can effectively resolve this problem.

In the present disclosure, it is important to realize that the current state-of-the-art in GPT models, including the latest GPT-4o, does not demonstrate sufficient capability to directly generate C from T. Therefore, an intermediate representation is necessary to bridge this gap. A causal graph emerges as a viable option because it delineates internal reasoning logic, thereby preventing GPT from generating nonexistent relationships between quantities through hallucination. The primary contribution of the causal graph lies in establishing the correct sequence for the command list, aligning with vertices along a desired path. Let G represent the internal graph associated with a question T, where V denotes the set of vertices and E denotes the set of edges, defining G=(V, E) as a directed graph. A directed graph, or digraph, is a graph in which the edges have directions. This structure allows for at most one edge from any vertex to another, capturing specific relationships between them. Vertices without a direct relationship do not have connecting edges. For subjects like Macroeconomics, a master Causal graph can be manually constructed, such as the one illustrated in FIG. 1, which is a one-time effort. G then functions as a sub-graph of this master Causal graph, represented by lists of vertex indices V and edge indices E. A typical syntax for G's representation might look at: {“START”: start vertex index, “END”: end node index, “EDGES”: list of edges in the path from start vertex to end vertex}. Multiple starting and ending points enable the representation of various paths. Using graph theory, paths can be derived straightforwardly from a directed graph once the starting and ending vertices are specified. The NLP understanding of T and generation of G can be achieved by using a GPT model (e.g., GPT 3.5) and it was observed that the accuracy is very high, which means: P (G|T)≈1. Once the G is obtained, the pair (T+G)−(A+C) can be fed into a GPT model (e.g., GPT 3.5), which aims to: max P (A, C|T, G). Then it can be derived that

$$P ( A , C \vert T , G ) = \frac{P ( A , C , T , G )}{P ( T , G )} = \frac{P ( A , C , T , G )}{P ( T ) P ( G \vert T )} \approx \frac{P ( A , C , T , G )}{P ( T )} = P ( A , C , G \vert T ) \approx P ( A , C \vert T ) ,$$

as (A, C) are almost independent from G.

Based on the preceding analysis, the network architecture of GraphGPT can be structured as shown in FIG. 5. The Causal Graph Transform module converts T into G. This transformed G is then concatenated with T and input into a machine learning model to train and generate A and C. The outputs A and C undergo processing in a text processing and rendering module. Here, A is separated from C, and the commands C are used to derive S and D. This step ensures that the process is presented in a format that is more intuitive for humans, complemented by diagrams to enhance user understanding. For some exemplary embodiment, the machine learning model can use an open sourced LLM model, such as GPT-2 or Llama, or a fine-tuned GPT model.

FIG. 6 illustrates a flowchart of an exemplary intuitive method for answering a question according to some embodiments of the present disclosure. The method is also called GraphGPT in the specification and is intended to achieve intuitive and interactive educational experiences. As shown in FIG. 6, the method includes the following process.

At S602, the user can set up or adjust the ILM (Intuitive Level Metric) according to individual preferences at any time, and the answers may be influenced accordingly after the ILM is adjusted. Some users may prefer detailed textual answers, while others may favor concise text. Similarly, some might like graphical illustrations for each step, whereas others might prefer graphics only for key steps. Additionally, preferences for colorful graphical illustrations versus more subdued, low-key colors can also be accommodated.

For some exemplary embodiments, let us denote by <a, b, c, d> the vector to represent the ILM, where ‘a’ signifies the weight of textual importance in the shown answer, ‘b’ indicates the weight of graphical illusion importance in the output answer, and ‘c’ reflects the importance of the number of the textual steps, ‘d’ reflects the importance of the number of colors used in drawing the diagram. It can be required that a+b+c+d=1.0, and all weights are in the range of [0.0, 1.0]. These ILM weights also influence the model's loss function, penalizing attribute errors according to the user's preferred factors. An exemplary loss function can be written as L=a*Eₜₑₓₜ+b*E_{cmd}+c*Eₛₜₑₚ+d*E_{color}, Where Eₜₑₓₜ, E_{cmd}, Eₛₜₑₚ and E_{color} represent the error (or difference between actual output and expected output) in the text answer, command, level of detail in describing text answer, and the number of colors in drawing. Since all text can be embedded as vectors using the popular Word2Vec approach, the similarity between two sentences can be measured by calculating the distance between the averaged word vectors in each sentence. Using this method, the similarities between the actual output text and the expected output, represented as Eₜₑₓₜ and E_{cmd} can be computed. Additionally, Eₛₜₑₚ and E_{color} can be determined by comparing the actual number of steps and colors in the output to the expected values. The loss function directly impacts how a machine learning model learns, adjusts, and performs on new tasks. It measures prediction errors, guides weight updates during training, and influences the model's ability to generalize to unseen data.

For the ILM, the system can offer users various ways to specify their preferred settings to reflect their intuitive level preference, allowing the metrics and the loss function to be adjusted accordingly. In some examples, users may prefer a concise answer, limiting the text response to fewer than five steps and the graphical diagram to fewer than four. In other examples, users might want purely graphical responses with fewer than eight steps. These preferences are integrated into the ILM settings, and a corresponding loss function is derived based on these configurations, as demonstrated in the example above.

At S604, the user will receive a multiple-choice question and will need to determine the correct answer.

At S606, a causal graph corresponding to the questions will be generated. Typically, a master causal graph is pre-defined for each subject. In this process, only a sub-graph of the master graph will be used. This means that only the nodes and edges relevant to the current questions and answers will be retained, while other parts of the master graph will be trimmed to create a causal graph that corresponds specifically to the current question.

At S608, the causal graph is represented in a text format using the following syntax: {“START”: start vertex index, “END”: end node index, “EDGES”: list of edges in the path from start vertex to end vertex}. The question text and the text representation of the causal graph are then concatenated and embedded using GPT's standard approach.

At S610, the embedded stream generated in S608 is inputted into an ILM-optimized machine learning model to generate an output text stream. Initially, the machine learning model can be an open sourced LLM model, such as GPT-2 or Llama, and pre-trained on vast datasets sourced from publicly available text across a wide range of domains. This training allows the model to learn patterns in language, grammar, context, reasoning, and information. Based on parameter setting in S602 and the corresponding loss function utilized, the parameters of the model will be adjusted during the training process with the new loss function, and with the new dataset specifically designed for the question and answers with variations of textual conciseness, number of commands for graphical drawing, and color richness. The training process using the loss function designed to favor ILM is indeed an ILM optimization process. The machine learning model learns, adjusts, and performs on the ILM optimization task by using the biased loss function and guide the weight updated during training.

In some embodiments, training the ILM-optimized machine learning module requires preparing training data that includes sample questions, the associated causal graph text representations, and the expected answers and commands according to various ILM settings. The loss function used in the machine learning model can be derived following the user's configuration in S602.

At S612, the output text stream generated from S610 is processed to derive an answer A and a list of commands C.

At S614, each command C in text format is further processed to derive S and D. The system first outputs S as the step instruction, and then generate a diagram based on the operation and operands embedded in the command.

At S616, the final answer A derived in S612 is outputted.

The present disclosure also provides a GraphGPT device. FIG. 7 illustrates a schematic structural diagram of an exemplary GraphGPT device according to some embodiments of the present disclosure. As shown in FIG. 7, the device 700 may include a processor 702, a storage medium 704, a display 706, a communication module 708, a database 710, and peripherals 712, and one or more bus 714 to couple the components together. Certain components may be omitted and other components may be included.

The processor 702 may include any appropriate processor or processors. Further, the processor 702 can include multiple cores for multi-thread or parallel processing. The processor 702 may execute sequences of computer program instructions or program modules to perform various processes, such as receiving a question with multiple choice answers; generating a causal graph corresponding to the question; transforming both the question and the causal graph into a concatenated text stream and embedding; inputting the embedded stream into an ILM-optimized machine learning module to generate an output text; processing the output text stream to generate an answer and a list of pairs of text steps and drawing commands; processing the list of pairs sequentially, first rendering the text step and then creating a drawing based on the command; and outputting the final answer choice. The storage medium 704 may include memory modules, such as ROM, RAM, flash memory modules, and erasable and rewritable memory, and mass storages, such as CD-ROM, U-disk, and hard disk, etc. The storage medium 704 may store computer program instructions or program modules for implementing various processes, when executed by the processor 702.

Further, the communication module 708 may include network devices for establishing connections through a communication network. The database 710 may include one or more databases for storing certain data (e.g., causal graphs, supplementary materials) and for performing certain operations on the stored data, such as database searching and data retrieving.

The display 706 may include any appropriate type of computer display device or electronic device display (e.g., CRT or LCD based devices, touch screens, LED display, or VR/AR/XR displays). The peripherals 712 may include various sensors and other I/O devices, such as speaker, camera, motion sensors, keyboard, mouse, etc.

In operation, the computing device 700 can perform a series of actions to implement the disclosed GraphGPT question answering method and framework. The computing device 700 can implement a terminal or a server, or a combination of both. A terminal, as used herein, may refer to any appropriate user terminal with certain computing capabilities including, e.g., collecting user-entered configuration, displaying final answers. For example, a terminal can be a personal computer (PC), a workstation computer, a server computer, a hand-held computing device (tablet), a mobile terminal (a mobile phone or a smartphone), or any other user-side computing device. A server, as used herein, may refer to one or more server computers configured to provide certain server functionalities, such as generating causal graph, conducting GPT process. The server may also include one or more processors to execute computer programs in parallel. The terminal and/or the server may be configured to provide structures and functions for such actions and operations. In some embodiments, some part of the actions may be performed on the server, and other part of the actions may be performed on the terminal.

In some embodiments, the terminal device communicates with the cloud server through HTTP API.

In the specification, specific examples are used to explain the principles and implementations of the present disclosure. The description of the embodiments is intended to assist comprehension of the methods and core inventive ideas of the present disclosure. At the same time, those of ordinary skill in the art may change or modify the specific implementation and the scope of the application according to the embodiments of the present disclosure. Thus, the content of the specification should not be construed as limiting the present disclosure.

What is claimed is:

1. A method for providing an answer, comprising:
receiving a question with a plurality of multiple choice answers;
generating a casual graph from the question with the multiple choice answers;
generating an answer choice and a list of pairs of text steps and drawing commands based on the causal graph; and
outputting the answer choice, one or more text steps and one or more drawings based on the drawing commands.

2. The method according to claim 1, further comprising:
providing an Intuitive Level Metric (ILM);
optimizing a machine learning model using the ILM.

3. The method according to claim 2, wherein the machine learning model is optimized by optimizing a loss function of the ILM, the loss function for optimizing ILM is L=a*Eₜₑₓₜ+b*E_{cmd}+C*Eₛₜₑₚ+d*E_{color}, wherein Eₜₑₓₜ, E_{cmd}, Eₛₜₑₚ and E_{color} respectively represent errors in text answer, command, number of steps in the text answer, and number of drawing colors.

4. The method according to claim 1, wherein the step of generating an answer choice comprises:
transforming the question and the casual graph into a concatenated text stream;
feeding the concatenated text stream into the ILM optimized machine learning model to generate an output text stream;
processing the output text stream to generate the answer choice and the list of pairs of text steps and drawing commands.

5. The method according to claim 1, wherein the step of outputting the answer choice, the one or more text steps and one or more drawings based on the drawing commands comprises:
processing the list of pairs of text steps to render text steps and create drawings based on the drawing commands;
output the answer choice; and
outputting in interleaved mode by displaying a text step followed by a drawing, if drawing commands are available for that step, and repeating this process iteratively until all text steps in the list are completed.

6. The method according to claim 2, wherein setting or adjusting the ILM includes:
determining an importance level of the text answer versus a graphical illustration;
determining a level of detail in describing the steps to solve the problem; and
determining a level of colorfulness of the graphical illustration.

7. The method according to claim 1, wherein generating the causal graph corresponding to the question comprises:
generating a sub-graph of a master graph corresponding to a current subject based on the question.

8. The method according to claim 4, wherein transforming the question and the causal graph into the concatenated text stream comprises:
transforming the causal graph into a transformed causal graph text stream including a raw text format following a predefined syntax;
concatenating the question in raw text format with the transformed causal graph text stream into the concatenated text stream; and
embedding the concatenated text stream into a format that a GPT model that is cable of understanding and processing.

9. The method according to claim 2, wherein inputting the embedded stream into an ILM-optimized machine learning module to generate an output text comprises:
preparing training data with ground truth sample questions, associated causal graph data, step-by-step text answers, and associated graph drawing commends;
training a machine learning model by minimizing a loss function that aims to optimize the highest ILM level; and
inputting the embedded stream into the trained model to generate output text stream.

10. The method according to claim 4, further comprises:
extracting the answer from the output text stream; and
extracting the list of pairs of text steps and drawing commands from the output text stream.

11. The method according to claim 4, further comprises:
processing the list of pairs in a sequential order;
rendering the text step in each pair as a current step; and
rendering a drawing based on the commend in the same pair, wherein the drawing is used to enhance the text step and make the answer more intuitive.

12. An intuitive optimized device for answering a question with graphical guided steps, comprising:
a memory storing program instructions; and
a processor coupled with the memory and configured to execute the program instructions to:
set or adjust an Intuitive Level Metric (ILM);
receive a question with multiple choice answers;
generate a causal graph corresponding to the question;
transform both the question and the causal graph into a concatenated text stream and embedding;
input the embedded stream into an ILM-optimized machine learning module to generate an output text;
process the output text stream to generate an answer and a list of pairs of text steps and drawing commands;
process the list of pairs sequentially, first rendering the text step and then creating a drawing based on the command; and
output the final answer choice.

13. An intuitive optimized system for answering a question with graphical guided steps, comprising:
a terminal device configured to:
set or adjust an Intuitive Level Metric (ILM);
receive a question with multiple choice answers;
send the request to a cloud server;
receive a text stream from the cloud server;
process the received text stream to generate an answer and a list of pairs of text steps and drawing commands;
process the list of pairs sequentially, first rendering the text step and then creating a drawing based on the command; and
output the final answer choice;
wherein the cloud server is configured to:
receive the question from the terminal device;
generate a causal graph corresponding to the question;
transform both the question and the causal graph into a concatenated text stream and embedding;
input the embedded stream into an ILM-optimized machine learning module to generate an output text; and
send the text stream to the terminal device.

14. The system according to claim 13, wherein:
the terminal device communicates with the cloud server through HTTP API.
